(19) United States
(12) Patent Application Publication
(10) Pub. No.: US 2026/0338238 A1
(43) Pub. Date: Oct. 29, 2026

(54) BISTABLE ELECTROMAGNETIC CLUTCH

(71) Applicant: Means Industries, Inc., Saginaw, MI (US)

(72) Inventors: Riley Moore, Flint, MI (US); Ali Merat, Fenton, MI (US)

(21) Appl. No.: 19/632,707

(22) Filed: Mar. 30, 2026

Related U.S. Application Data
(60) Provisional application No. 63/793,037, filed on Apr. 23, 2025.

(51) Int. Cl. F16D 27/00; F16D 27/14; F16D 121/20

(52) U.S. Cl. CPC F16D 27/004; F16D 27/14; F16D 2027/005; F16D 2027/008; F16D 2121/20

(57) ABSTRACT

An electromagnetic clutch coupling subsystem includes a locking member carried by a pocket of a second coupling member, and engaged with a locking formation of a first coupling member in a locked position, and disengaged from the locking formation in an unlocked position. An electromagnetic clutch actuator subsystem includes first and second pole extensions rotatable with the second coupling member, and a permanent magnet generating a persistent magnetic flux contribution within the first and second pole extensions to influence motion of the locking member. An electromagnetic coil generates a selective magnetic flux contribution within the first and second pole extensions, and influencing motion of the locking member, having a magnitude and direction variable according to a magnitude and direction of current in the electromagnetic coil, and superimposing with the persistent magnetic flux contribution to create a selectively variable net magnetic force on the locking member.

This application claims the benefit of and priority to U.S. Provisional Application No. 63/793,037, filed Apr. 23, 2025, the contents of which is incorporated herein by reference in its entirety.

### TECHNICAL FIELD

This disclosure relates generally to clutches and, more particularly, to electromagnetically actuated dynamic clutches having struts or pawls.

### BACKGROUND

An example of an automotive clutch includes an input side rotatable in forward and reverse rotational directions about a rotation axis, an output side rotatable in both of the directions about the rotation axis, one or more locking members that are disposed between the input and output sides, and an actuation system to move the locking members to change states of the clutch from one state to another state. For example, the actuation system can move the locking members so that the clutch can change from a fully unlocked state where the input and output sides are rotationally unlocked and free to rotate relative to each other in both directions, to a fully locked state where the input and output sides are rotationally locked together in both directions. In another example, the actuation system can move the locking members so that the clutch can change from the fully locked state to the fully unlocked state. In a further example, the actuation system can move the locking members so that the clutch can change from either the fully unlocked state or the fully locked state to a one-way-clutch mode, where the input and output sides can rotate relative to each other in only one direction and carry torque in the other direction.

A more specific example of an automotive clutch also requires an ability to actuate the clutch while its input and output sides are both rotating. Such a clutch may be referred to as a dynamic clutch, in contrast to a static clutch that has one side always stationary (for example, because it is splined to a transmission case). The dynamic clutch presents challenges in actuating the clutch from one state to another, because its actuation system has a power source that is stationary, and the clutch must be able to transfer forces from the stationary power source to the rotating clutch to cause the locking members to move so that the clutch changes state. In some dynamic clutches, the locking members are electromagnetically actuated struts or pawls. In a specific example, another dynamic clutch includes a linear actuation system including a non-rotating stator that exerts a linear force on a rotating translator along the rotational axis, wherein the translator correspondingly exerts an actuation force on the struts to change their position and thereby change the state of the clutch. An example of such a linear actuation system is disclosed in U.S. Patent 9,435,387, which is assigned to the assignee of the present application.

A different type of actuation system for a strut-type dynamic clutch comprises a stationary coil assembly and a pair of pole pieces carried by one of the sides of the clutch. The pole pieces provide a path for magnetic flux to flow from the stationary coil assembly directly to the strut and to apply a magnetic force directly on the strut to change its position and thereby change the clutch state. This type of actuation system is disclosed in U.S. Patent 10,995,803, which is assigned to the assignee of the present application. This actuation system has some benefits over a linear actuation system, such as elimination of the translator and elimination of friction that resists the translator’s linear motion at high speeds. At least some embodiments of the ‘803 patent disclose a peak-and-hold actuation system that requires persistent delivery of electrical current to the stationary coil assembly after an initial current pulse in order to maintain attractive force on the strut and maintain the clutch state. But such peak-and-hold actuation systems may consume an undesirable amount of power or may not work if power is interrupted.

### BACKGROUND

An illustrative embodiment of an electromagnetic clutch includes first and second coupling members supported for rotation relative to one another about a common rotational axis, the first and second coupling members including first and second faces in opposition with one another, the second coupling member having a third face spaced from the second face, the second face having a pocket, the first face having a set of locking formations, and the third face having at least one passage in communication with the pocket. The clutch also includes magnetic circuit components including a ferrous locking member received in the pocket in an unlock position and projecting outwardly from the pocket in a lock position, and an electromagnet including first and second poles, and an excitation coil that generates a selective magnetic field between the first and second poles when the excitation coil is supplied with current. The components further include magnetic first and second inserts received in the at least one passage of the second coupling member, and a permanent magnet between the first and second inserts. The first and second inserts are in opposition across first and second air gaps with the first and second poles of the electromagnet, the first and second inserts being in opposition across third and fourth air gaps with first and second spaced portions of the ferrous locking member, wherein the electromagnet, the inserts, the air gaps, and the ferrous locking member constitute a closed-loop path of magnetic flux so that the ferrous locking member moves between the unlock and lock positions when the excitation coil is supplied with current.

An illustrative embodiment of a clutch system includes a coupling subsystem including a first coupling member, a second coupling member, and a locking member operatively positioned between the first coupling member and the second coupling member, and movable between a first position and a second position. The clutch system also includes an actuator subsystem including an electromagnetic coil assembly that includes an electromagnetic coil winding, and a coil housing having a first pole and a second pole, wherein the electromagnetic coil assembly is configured so that magnetic flux is produced in the coil housing when the electromagnetic coil winding is energized with current. The actuator subsystem further includes a first pole extension rotatable with the second coupling member, the first pole extension magnetically interfacing with the first pole of the coil housing and magnetically interfacing with the locking member, and a second pole extension rotatable with the second coupling member, the second pole extension magnetically interfacing with the second pole of the coil housing and magnetically interfacing with the locking member. The actuator subsystem also includes a permanent magnet rotatable with the second coupling member, the permanent magnet magnetically interfacing with the first pole extension and magnetically interfacing with the second pole extension, wherein the coil housing, the first pole extension, the second pole extension, and the locking member form a first magnetic loop so that magnetic flux generated by the electromagnetic coil winding is extendable to the locking member through the first and second pole extensions, and wherein the permanent magnet, the first pole extension, the second pole extension, and the locking member form a second magnetic loop so that magnetic flux generated by the permanent magnet is extendable to the locking member through the first and second pole extensions.

Another embodiment of an electromagnetic clutch includes a coupling subsystem including a first coupling member having a locking formation, a second coupling member in opposition with the first coupling member and having a pocket, and a locking member that is carried by the pocket of the second coupling member, is engaged with the locking formation of the first coupling member in a locked position of the locking member to transmit torque between the first and second coupling members, and is disengaged from the locking formation in an unlocked position of the locking member. The clutch also includes an actuator subsystem including first and second pole extensions rotatable with the second coupling member, and a permanent magnet that generates a persistent magnetic flux contribution within the first and second pole extensions, the persistent magnetic flux contribution influencing motion of the locking member between the locked and unlocked positions. The actuator subsystem further includes an electromagnetic coil that generates a selective magnetic flux contribution within the first and second pole extensions, the selective magnetic flux contribution influencing motion of the locking member between the locked and unlocked positions, magnitude and direction of the selective magnetic flux contribution being variable according to magnitude and direction of current in the electromagnetic coil, the selective magnetic flux contribution superimposing with the persistent magnetic flux contribution of the permanent magnet to create a net magnetic force acting on the locking member that can be varied selectively.

### BRIEF DESCRIPTION OF THE DRAWINGS

The present disclosure will become better understood with reference to the following description, appended claims, and accompanying drawings where:

FIG. 1 is a perspective view of a clutch system constructed in accordance with an embodiment of the present disclosure and in a fully assembled condition;

FIG. 2 is a partially exploded perspective view of the clutch system of FIG. 1, with an electromagnetic coil assembly separated from the rest of the system;

FIG. 3 is another partially exploded perspective view of the clutch system of FIG. 1, with a first coupling member separated from the rest of the system;

FIG. 4 is an exploded perspective view of the clutch system of FIG. 1;

FIG. 5 is an enlarged, fragmentary, upper perspective view of the clutch system of FIG. 1 with the first coupling member removed, showing a spring biasing a locking member toward a locked position within a pocket of a second coupling member, and showing first and second pole pieces magnetically interfacing with the locking member;

FIG. 6 is an enlarged, lower perspective view of the locking member of FIG. 5, showing first and second spaced portions that magnetically interface with the first and second pole pieces of FIG. 5;

FIG. 7 is an enlarged, fragmentary, cross-sectional view of the clutch system of FIG. 1, taken along a radially extending plane intersecting the locking member and a permanent magnet, and showing first and second magnetic loops with dashed lines;

FIGS. 8A and 8B are enlarged fragmentary schematic side views of the locking member, the pole pieces, and a spring of the clutch system of FIG. 1, and arrows indicating torques exerted on the strut by the permanent magnet and the spring, where FIG. 8B shows the locking member stable in a second position (locked position) with no current in the coil winding and where FIG. 8A shows the locking member stable in a first position (unlocked position) with no current in the coil winding;

FIG. 9A is a fragmentary, cross-sectional view of the clutch system of FIG. 1, taken along a radially extending plane intersecting the locking member and the permanent magnet, and illustrating magnetic loops indicating magnitude and direction of magnetic flux;

FIG. 9B is an enlarged, fragmentary, schematic side view of the locking member, the spring, and one of the pole pieces of FIG. 5, and an arrow indicating a direction of motion of the locking member when the coil winding is energized per FIG. 9A;

FIG. 10A is a fragmentary, cross-sectional view of the clutch system of FIG. 1, taken along a radially extending plane intersecting the locking member and the permanent magnet, and illustrating magnetic loops indicating magnitude and direction of magnetic flux;

FIG. 10B is an enlarged, fragmentary, schematic side view of the locking member, the spring, and one of the pole pieces of FIG. 5, and an arrow indicating a direction of motion of the locking member when the coil winding is energized per FIG. 10A; and

FIG. 11 is a graph plotting torque vs. magnetomotive force during operation of the clutch system of FIG. 1.

### DETAILED DESCRIPTION

In general, a novel, strut- or pawl-type, electromagnetically actuated bistable dynamic clutch system will be described below in conjunction with one or more illustrative embodiments. The clutch system uses a combination of an electromagnetic actuator and permanent magnets to achieve a bistable characteristic, such that no electrical power is consumed while transitioning between operational states. The clutch system also has relatively few moving parts due to a magnetic circuit arrangement that extends magnetic flux directly to the strut or pawl (also called a locking member). The illustrative embodiments will be described with reference to use of the clutch system with automotive dynamic clutches. However, it will be appreciated as the description proceeds that the novel clutch system is not limited to use with automotive dynamic clutches and is useful in many different applications and may be implemented in many other embodiments.

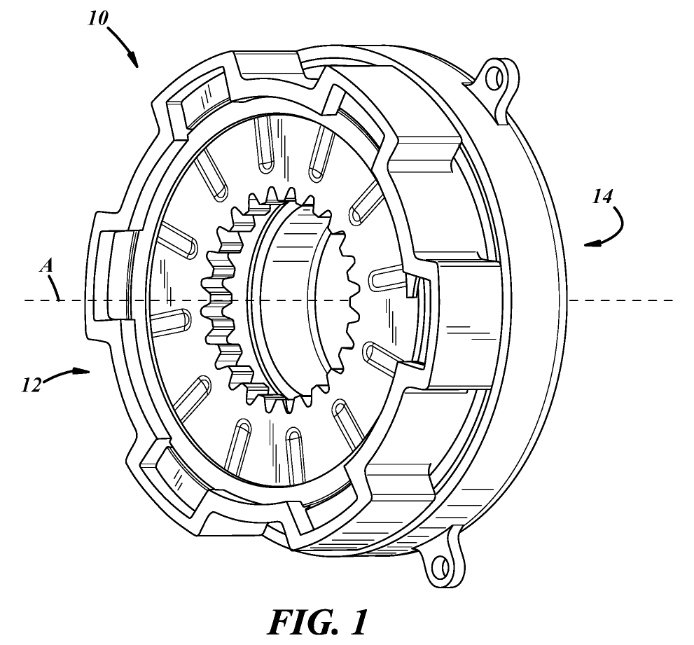

With specific reference to the drawing figures, FIG. 1 illustrates a clutch system 10 including a coupling subsystem 12, and actuator subsystem 14 that is adjacent to the coupling subsystem 12 and configured to actuate the coupling subsystem 12. The actuator subsystem 14 uses electrical current to generate a magnetic field that influences one or more operational states of the coupling subsystem 12, as will be described in detail below. The clutch system 10 may be an electromagnetically-actuated, bistable, dynamic clutch system 10. The clutch system 10 may be used in a vehicle powertrain or drivetrain to connect or disconnect powertrain or drivetrain components for various reasons, for example, shifting gears of a transmission by coupling/uncoupling related components in the transmission, changing states of a drivetrain by coupling/uncoupling related drive components, and the like.

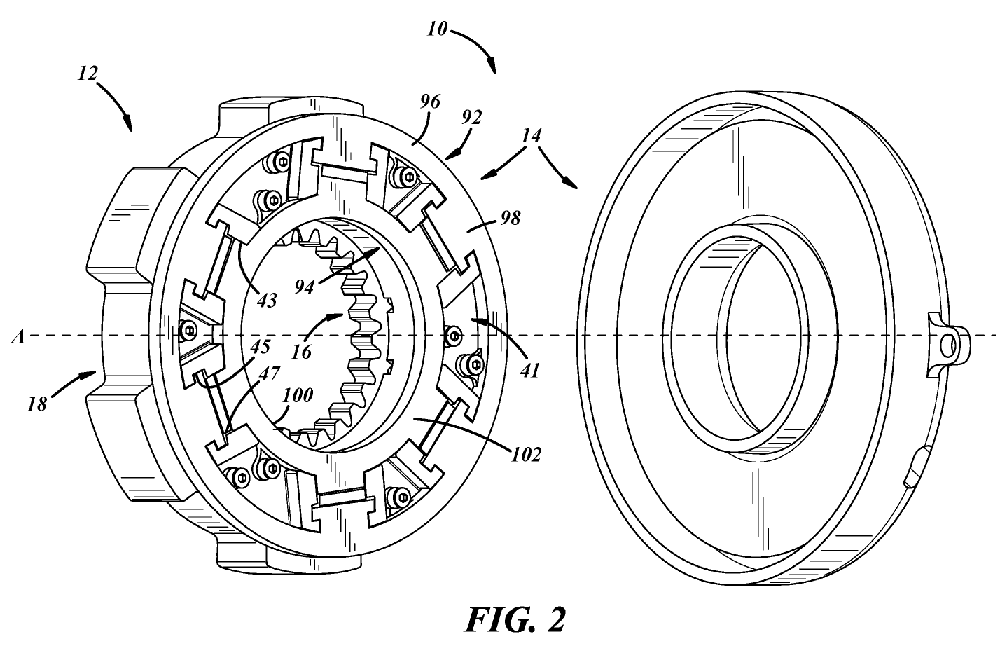

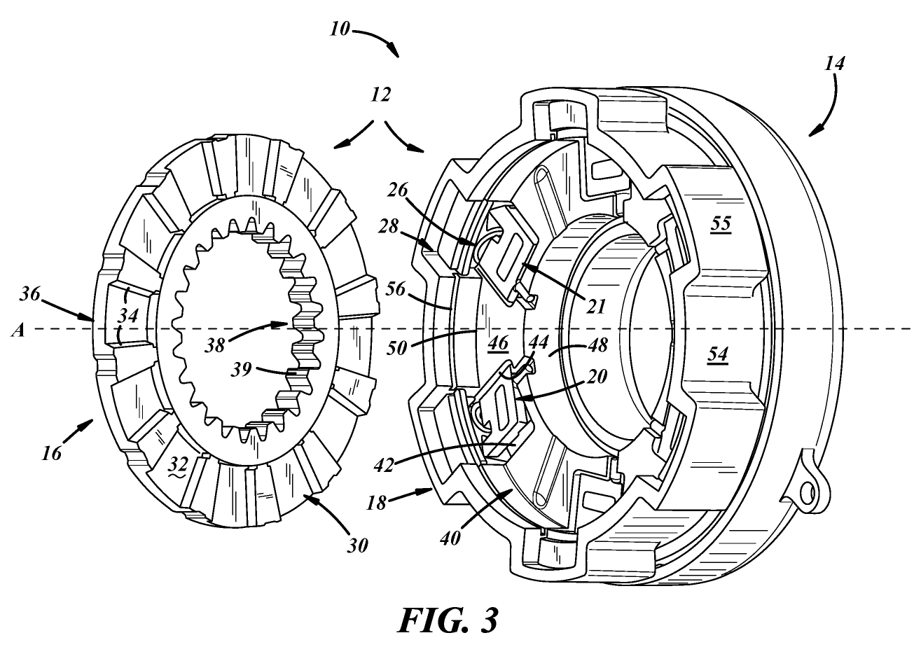

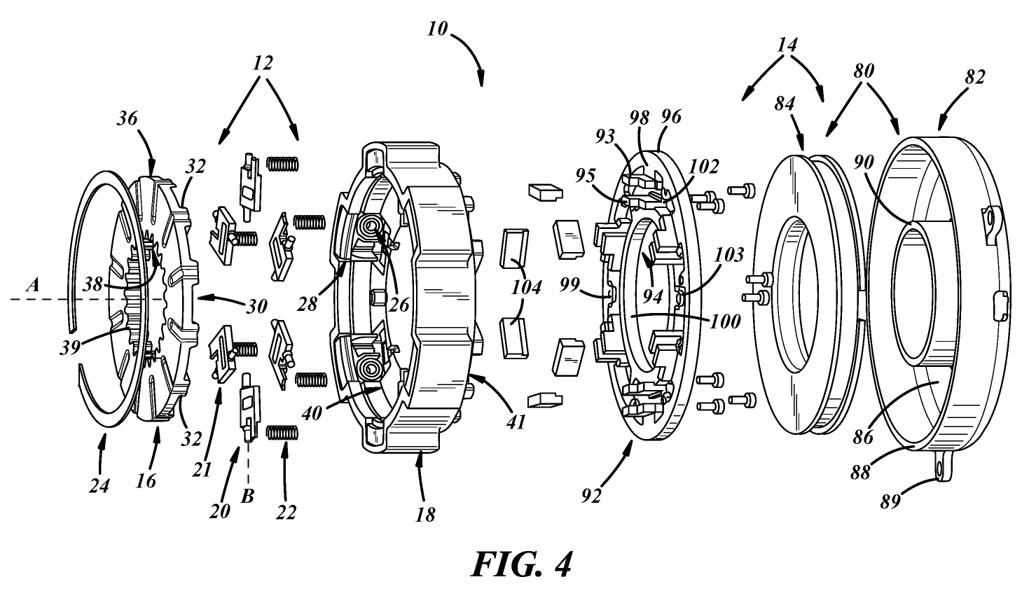

Referring now to FIGS. 2-4, the coupling subsystem 12 includes a first coupling member 16 and a second coupling member 18 supported for rotation relative to one another about a common rotational axis A (FIG. 1). The coupling members 16, 18 instead may be termed clutch members. With reference now to FIGS. 3 and 4, the coupling subsystem 12 also includes sets of locking members 20, 21 which are operatively positioned between the first and second coupling members 16, 18, meaning that the locking members 20, 21 can cause a connection between the first and second coupling members 16, 18 depending on the position of the locking members 20, 21. The actuator subsystem 14 may be activated to result in pivoting of the locking members 20, 21 toward the first coupling member 16 and away from the second coupling member 18, and/or vice-versa. In the illustrated embodiment, the coupling subsystem 12 is configured to be used as a dynamic clutch wherein the first and second coupling members 16, 18 are both rotatable about the rotational axis A. But in other embodiments, the coupling subsystem 12 may be configured to be used as a static clutch, where only one of the coupling members 16, 18 rotates and the other is stationary. In the illustrated embodiment, the coupling subsystem 12 includes a planar clutch, wherein pivoting motion of the locking members 20, 21 is in an axial direction relative to the rotational axis A because the first and second coupling members 16, 18 are adjacent to each other in the axial direction. But in other embodiments, the coupling subsystem 12 may include a radial clutch, wherein first and second coupling members may be nested radially and so that locking members pivot in a radial direction relative to a rotational axis, and wherein magnetic interface connections and operation are the same or similar to that described herein, and specific shapes and orientations of various components may change.

With reference now to FIG. 4, the quantity of locking members 20, 21 may vary and the locking members 20, 21 may be arranged to face in opposite rotational directions. More specifically, a first set of locking members 20 faces in a first circumferential/rotational direction and a second set of locking members 21 faces in a second circumferential/rotational direction opposite of the first circumferential/rotational direction. In the illustrated embodiment, both sets of locking members 20, 21 are actively controllable, for example, spring-biased to one position and actuatable to the other position by the actuator subsystem 14. But in another embodiment, sets of locking members may be oriented to face in only one rotational direction. And in other embodiments, one set of the locking members may be oriented to face a rotationally forward direction and may be passive, meaning that they are only spring-biased toward the locked/engaged position with no means for actuating them to the unlocked/disengaged position, and another set of locking members may be oriented to face in a rotationally reverse direction and may be controllable as described herein below. In such cases where only a subset of locking members are controllable, the controllable locking members may be controlled as described herein below and the passive locking members would have no interface with the actuator subsystem 14 so that they maintain one-way torque transmission function regardless of any current flowing in the actuator subsystem 14. Similarly, in yet another embodiment, a controllable set of locking members facing one rotational direction may be controlled in one manner, and another controllable set of locking members facing the opposite rotational direction may be controlled in a different manner. In a further embodiment, only one set of controllable locking members all facing in the same rotational direction may be used.

With continued reference to the illustrated embodiment of FIG. 4, an advance spring 22 may be used with each of the locking members 20, 21 to impose a spring force on each of the locking members 20, 21 to urge or bias the locking members 20, 21 in a direction outward and away from the second coupling member 18 toward the first coupling member 16. In the illustrated embodiment, the spring 22 is a coil compression spring. In other embodiments, the spring 22 may be a coil tension spring, an elastomeric spring, a coil torsional spring, a thin and flexible stamping, or any other biasing means suitable for pivoting the locking members 20, 21. The spring 22 may act on either side of a pivot axis B of the respective locking member 20, 21, and can either push or pull on the locking member 20, 21. The coupling subsystem 12 further may include a retainer 24 to retain the first coupling member 16 to the second coupling member 18. With additional reference to FIG. 3, the coupling subsystem 12 additionally may include bearings 26 to pivotably support the locking members 20, 21, and bearing blocks 28 that house the bearings 26 and that are carried by the second coupling member 18.

With reference again to FIGS. 3 and 4, the first coupling member 16 may be referred to as a notch plate, and includes a notch face or first face 30 having a set of notches or locking formations 32 with engagement surfaces 34 to engage corresponding portions of the locking members 20, 21. The first coupling member 16 also includes an outer diameter 36, and an inner diameter 38 that may be splined to include splines 39, for example, for coupling against relative rotation to a shaft, hub, or some other component (not shown). Accordingly, the first coupling member 16 may be a rotatable member, more specifically, a rotatable input member or a rotatable output member.

The second coupling member 18 may be referred to as a pocket plate, and includes a pocket face or second face 40 in opposition to the first face 30 of the first coupling member 16, and an actuator face or third face 41 (FIG. 4) on a side of the second coupling member 18 opposite that of the second face 40. The second face 40 has a set of pockets 42 with engagement surfaces 44. The pockets 42 carry the locking members 20, 21 therein, and the engagement surfaces 44 engage corresponding portions of the locking members 20, 21 at least when the coupling subsystem 12 is actuated/engaged. The second face 40 may be part of a base wall 46 of the second coupling member 18 that may have an inner diameter 48 corresponding to but larger than the inner diameter 38 of the first coupling member 16, and that also may have an outer diameter 50. With reference again to FIG. 2, the third face 41 includes a plurality of radially outer or first pole passages 43, a plurality of radially inner or second pole passages 45, and a plurality of magnet pockets 47 therebetween, that may extend into or through the base wall 46 of the second coupling member 18. With reference again to FIG. 3, the inner diameter 48 may be smooth as illustrated, but in other embodiments an inner diameter may be splined to include splines for coupling to a shaft, hub, or other component (not shown). The second coupling member 18 also includes an annular wall 54 extending away from the outer diameter 50 in which the outer diameter 36 of the first coupling member 16 may be received in assembly, and including radially outer bosses 55 establishing outer pockets to receive the bearing blocks 28 therein, and a groove 56 to receive the retainer 24 to retain the first coupling member 16 with respect to the base wall 46 of the second coupling member 18 and to retain the bearing blocks 28 in the radially outer pockets of the radially outer bosses 55.

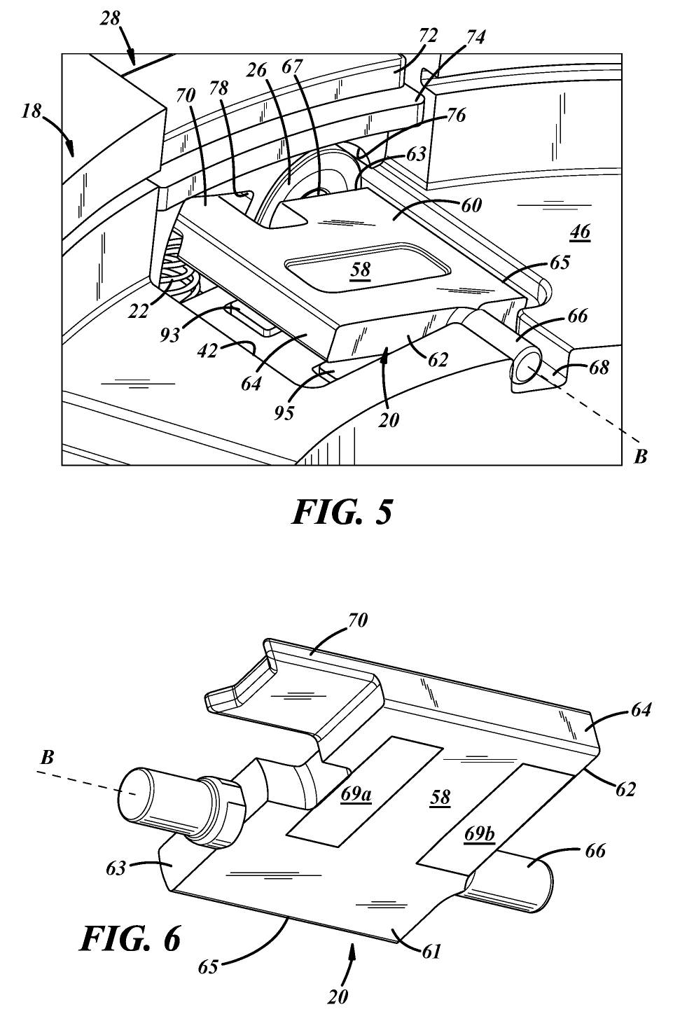

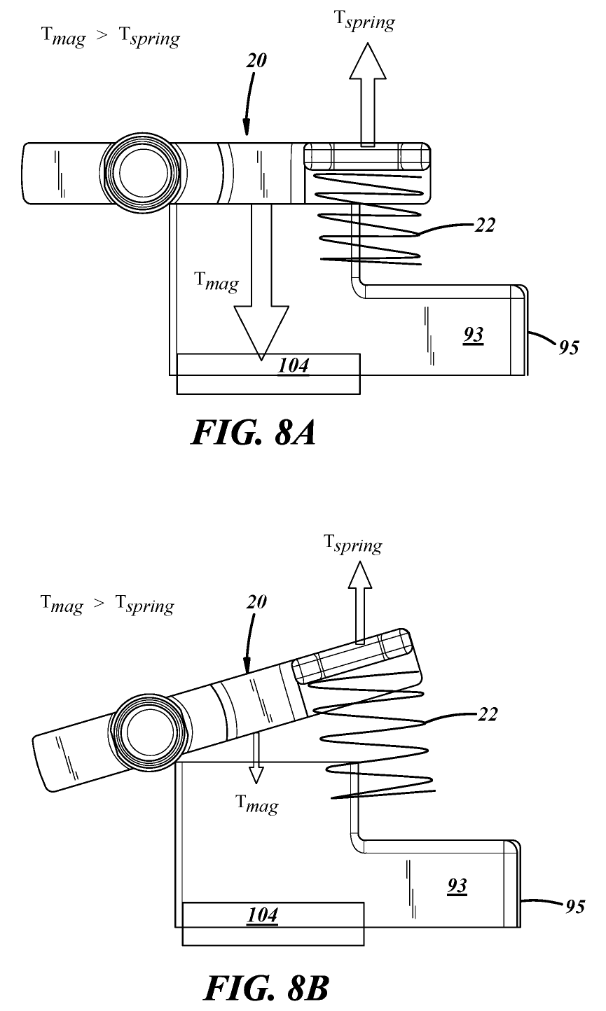

With primary reference now to FIG. 5 and supplemental reference to FIG. 6, the locking members 20, 21 (only the first locking member 20 shown) may be referred to as pawls or struts. The locking members 20, 21 may be composed of a ferrous material, for example, steel, or any other ferrous material suitable for use in the present disclosure, such that the locking members 20, 21 may be ferrous locking members. Each locking member 20, 21 is pivotable about its own pivot axis B from a disengaged/unlocked position (FIG. 8A) in its corresponding pocket 42 of the second coupling member 18, to an engaged/locked position/orientation (FIG. 8B) protruding obliquely out of its corresponding pocket 42 (FIG. 5). Each locking member 20, 21 includes a body 58 having axially oppositely disposed faces 60 (FIG. 5), 61 (FIG. 6), sides 62, 63 extending between the faces 60, 61, and ends 64, 65 extending between the faces 60, 61 and the sides 62, 63. Each locking member 20, 21 also may include a radially inner pivot ear 66 that may extend radially inwardly from a radially inner one of the sides 62 and may be carried in a corresponding ear notch 68 in the base wall 46 of the second coupling member 18, and a radially outer pivot ear 67 that may extend radially outwardly from a radially outer side 63 and be carried in an inner diameter of a corresponding one of the bearings 26. Each locking member 20, 21 includes first and second spaced portions 69a,b (FIG. 6) on a rear one of the faces 61 for interacting with the actuator subsystem 14 as will be described in detail further herein below. Each locking member 20, 21 further may include a reaction arm 70 that may extend radially outwardly from the radially outer side 63 for cooperation with the advance spring 22. Relatedly, the bearing block 28 may include a radially inner base wall 72, a retainer flange 74 extending circumferentially and radially inwardly from the radially inner base wall 72, a bearing pocket 76 in the base wall 72 to receive the bearing 26, and a relief 78 in the base wall 72 to accommodate movement of the reaction arm 70 of each locking member 20, 21 and the advance spring 22.

With reference again to FIG. 3, when each locking member 20, 21 is in its first position (unlocked position), each locking member 20, 21 does not contact its corresponding first engagement surface 34 of the first coupling member 16, and when each locking member 20, 21 is in the second position (locked position, projecting outwardly from the pocket 42), it contacts both its corresponding first engagement surface 34 of the first coupling member 16 and its corresponding second engagement surface 44 of the second coupling member 18, thereby preventing relative rotation between the first and second coupling members 16, 18 in the rotational direction that corresponds to the position of the particular locking member 20, 21. In other words, the locking member 20, 21 is engaged with the locking formation 32 of the first coupling member 16 in the locked position and disengaged from the locking formation 32 in the unlocked position.

With reference again to FIG. 4, the actuator subsystem 14 includes an electromagnetic coil assembly 80 that may be a non-rotatable or non-rotating portion of the actuator subsystem 14. The electromagnetic coil assembly 80 includes a coil housing 82 and an electromagnetic coil winding 84 at least partially carried in the coil housing 82. The coil winding 84 may include a bobbin and wire wound around the bobbin. The coil housing 82 wraps partially around the coil winding 84 and includes a base wall 86 against which the winding 84 may be located in assembly, a first housing pole 88 extending away from the base wall 86, mounting flanges 89 extending radially outwardly from the first housing pole 88 for fixed mounting of the electromagnetic coil assembly 80, and a second housing pole 90 spaced radially inwardly from the first housing pole 88 and extending away from the base wall 86. When the coil winding 84 is energized with current, magnetic flux is produced in the coil housing 82 between the first and second housing poles 88, 90. The electromagnetic coil assembly 80 may be referred to as an electromagnet, and the coil winding 84 may be referred to as an excitation coil. Because magnetic flux in the coil housing 82 depends on current in the coil winding 84, the magnetic flux in the coil housing 82 can be referred to as a selective magnetic field, wherein the selective magnetic field can be deactivated, activated in a first direction, activated in a second direction opposite of the first direction, or variably adjusted in either direction. Although not separately illustrated, the actuator subsystem 14 may include, or may be configured to interface with, a power supply, wires, connectors, controllers, and any other suitable ancillary devices, components, or equipment.

The actuator subsystem 14 also includes first and second pole extensions 92, 94 that are rotatable with the second coupling member 18. The pole extensions 92, 94 effectively extend the poles 88, 90 of the housing 82 of the electromagnetic coil assembly 80 to conduct, direct, guide, bridge, or transmit magnetic flux therethrough, and alternatively may be referred to as magnetic flux conductors, directors, guides, bridges, transmitters, or the like. The first and second pole extensions 92, 94 may be screwed to the second coupling member 18 by cap screws or any other suitable fasteners, or may be interference fit, crimped, or fastened to the second coupling member 18 in any manner suitable with the teachings of the present disclosure. The first pole extension 92 is illustrated as including a radially outer annulus 96, pole spokes 98 extending radially inwardly from the radially outer annulus 96, pole pieces 93 that may extend axially away from the pole spokes 98 and that are carried in the first pole passages 43, and radially inwardly extending fastener flanges 99. The second pole extension 94 is illustrated as including a radially inner annulus 100, pole spokes 102 extending radially outwardly from the radially inner annulus 100, pole pieces 95 that may extend axially away from the pole spokes 102 and that are carried in the second pole passages 45, and radially outwardly extending fastener flanges 103. The pole pieces 93, 95 may be L-shaped as shown in FIG. 4. The pole pieces 93, 95 of the illustrated embodiment are arrays of circumferentially spaced integral portions of the pole extensions 92, 94 that effectively terminate the pole extensions 92, 94 and have terminus portions that magnetically interface with the locking members 20, 21. Alternatively, the pole pieces 93, 95 may be referred to as “inserts” or “pole terminals” or the like. In other embodiments, the pole pieces 93, 95 may be arrays of circumferentially spaced discrete pole extensions having not only their terminus portions that magnetically interface with the locking members 20, 21 but also origin portions that magnetically interface with the poles 88, 90 of the housing 82 of the electromagnetic coil assembly 80. In other words, the pole extensions 92, 94 may be larger circumferentially continuous components having the unitary annuluses 96, 100, spokes 98, 102, and pole pieces 93, 95, or may be constituted from a plurality of discrete circumferentially spaced instances of pole pieces. With reference to FIG. 2, the pole passages 43, 45 of the second coupling member 18 may be separate passages through the base wall 46 thereof or, although not illustrated, may be portions of a larger common pole passage therethrough receiving both pole pieces 93, 95.

With reference again to FIG. 4, the actuator subsystem 14 further includes a set of permanent magnets 104 rotatable with the second coupling member 18 and that may be carried by the second coupling member 18, more specifically, in the magnet pockets 47 (FIG. 2) of the second coupling member 18 between the first pole pieces 93 and the second pole pieces 95. The permanent magnets 104 are circumferentially aligned with the locking members 20, 21 to be able to magnetically interact with them. The permanent magnets 104 may be magnetized in a direction extending away from the first pole pieces 93 toward the second pole pieces 95, or vice versa. Each of the permanent magnets 104 generates its own persistent magnetic field.

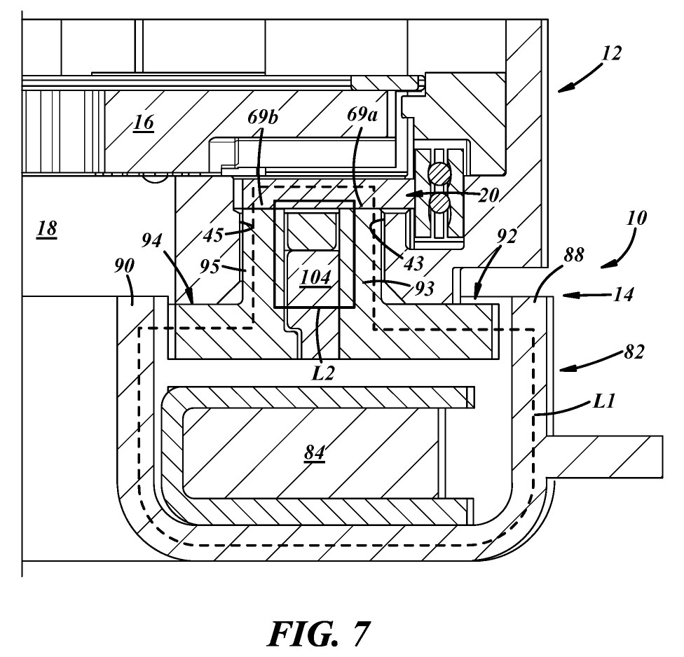

Referring now to FIG. 7, in the assembled condition of the clutch system 10, various components magnetically interface to form two magnetic loops, also called magnetic circuits, which are closed-loop paths of magnetic flux. The illustrated first pole extension 92 magnetically interfaces with the first housing pole 88 of the coil housing 82 via an origin portion of its annulus 96 and also with the locking member 20, 21 via the terminus portion of the first pole piece 93. The illustrated second pole extension 94 magnetically interfaces with the second housing pole 90 of the coil housing 82 via an origin portion of its annulus 100 and also with its corresponding locking member 20, 21 via the terminus portion of the second pole piece 95. Accordingly, the coil housing 82, the first pole extension 92 and pole piece 93, the second pole extension 94 and pole piece 95, and the locking member 20, 21 form a first magnetic loop L1 so that magnetic flux generated by the coil winding 84 is extendable to the locking member 20, 21 through the first and second pole extensions 92, 94 and pole pieces 93, 95. The first and second pole pieces 93, 95 are in opposition across corresponding first and second air gaps with the first and second housing poles 88, 90 of the electromagnetic coil assembly 80. The permanent magnet 104 magnetically interfaces with the first pole extension 92 and pole piece 93 and also with the second pole extension 94 and pole piece 95. Accordingly, the permanent magnet 104, the first pole extension 92 and pole piece 93, the second pole extension 94 and pole piece 95, and the respective locking member 20, 21 form a second magnetic loop L2 so that magnetic flux generated by the permanent magnet 104 is extendable to the respective locking member 20, 21 through the first and second pole extensions 92, 94 and pole pieces 93, 95. The first and second pole pieces 93, 95 are in opposition across third and fourth air gaps with the first and second spaced portions 69a,b of the locking member 20, 21. The coil winding 84 passes through the first magnetic loop L1. The terminology “magnetically interfacing” and its variants mean that some features of various components are positioned close enough to each other to allow magnetic flux to pass from one component to the other. Generally, the features would be positioned as close as is practical because close positioning reduces magnetic reluctance of any air gap between the components and therefore requires less current to produce a given force output, but the size of the air gap can be adjusted.

The magnetic circuit components, including the coil housing 82, the first and second pole extensions 92, 94, and the locking members 20, 21, are made of a magnetically permeable (i.e. “magnetic”, or “magnetically responsive”) material, for example, steel, or any other ferrous materials suitable for use with the teachings of the present disclosure. The permanent magnet 104 can be composed of, for example, neodymium, ferrite, AlNiCo, or any other permanent magnet material suitable for use with the teachings of the present disclosure. The components of the clutch system 10 that are not part of the first magnetic loop L1 or the second magnetic loop L2, such as the first and second coupling members 16, 18, may be composed of materials that have relatively low magnetic permeability or are not magnetically responsive, such as aluminum, plastic, some stainless steels, or any other suitable such materials.

With continued reference to FIG. 7, the coil winding 84 generates a selective magnetic flux contribution within the first magnetic loop L1 that influences motion of the locking member 20, 21 between the locked and unlocked positions. The selective magnetic flux contribution varies depending on the magnitude and direction of the current in the coil winding 84, including both forward and reverse flux directions, and including a condition of zero magnetic flux contribution when the current is zero. The permanent magnet 104 generates a persistent magnetic flux contribution within the second magnetic loop L2 that influences motion of the locking member between the locked and unlocked positions. The first and second magnetic loops L1, L2 coincide near the locking member 20, 21, and the magnetic flux contributions from the coil winding 84 and the permanent magnet 104 superimpose in that region to create a net magnetic force acting on the locking member 20, 21. The net magnetic force acting on the locking member 20, 21 influences the motion of the locking member 20, 21 between the first position and the second position.

FIGS. 8A and 8B illustrate the locking member 20, 21, the pole pieces 93, 95, and the advance spring 22, indicating how magnitudes and directions of individual magnetic and spring forces exerted on the locking member 20, 21 by the permanent magnet 104 and the spring 22 establish resultant torques (or moments) on the locking member 20, 21 about its pivot axis to create a bistable characteristic of the locking member 20, 21 when there is no current in the coil winding of the actuator subsystem. FIG. 8A shows the locking member 20, 21 stable in the first position (unlocked position) with no current in the coil winding, and FIG. 8B shows the locking member 20, 21 stable in the second position (locked position) with no current in the coil winding 84. When there is no current in the coil winding 84, the selective magnetic flux contribution is zero and the persistent magnetic flux contribution remains, creating a net magnetic force attracting the locking member 20, 21 toward the first position (unlocked position). The persistent magnetic flux contribution urges the locking member 20, 21 toward the unlocked position in an absence of the selective magnetic flux contribution. The advance spring 22 urges the locking member 20, 21 toward the second position (locked position). The attractive force applied by the permanent magnet 104 reduces as the locking member 20, 21 moves toward the second position (locked position), and the force applied by the spring 22 reduces less with the same movement. When the locking member 20, 21 is in the first position (unlocked position, FIG. 8A), the attractive force applied by the permanent magnet 104 generates or results in a torque on the locking member 20, 21 that exceeds the torque on the locking member 20, 21 resulting from the force applied by the spring 22, and so the locking member 20, 21 is stable in that position. Stated another way, when the locking member 20, 21 is in the unlocked position in the absence of the selective magnetic flux contribution, the persistent magnetic flux contribution produces the net magnetic force that urges the locking member 20, 21 toward the unlocked position more strongly than the spring force urges the locking member 20, 21 toward the locked position, so the locking member 20, 21 is stable in the unlocked position. When the locking member 20, 21 is in the second position (locked position, FIG. 8B), the force applied by the spring 22 results in a torque on the locking member 20, 21 that exceeds the torque on the locking member 20, 21 resulting from the attractive force applied by the permanent magnet 104 and so the locking member 20, 21 is stable in that position. Stated another way, when the locking member 20, 21 is in the locked position, the spring force urges the locking member 20, 21 toward the locked position more strongly than the persistent magnetic flux contribution urges the locking member 20, 21 toward the unlocked position, so the locking member 20, 21 is stable in the locked position. In this way, the position of the locking member 20, 21 is bistable when there is no current in the coil winding 84. The position of the locking member 20, 21 can be controlled by varying the magnitude and direction of current in the coil winding 84, thereby creating a selective magnetic flux contribution that either supplements or cancels out the persistent magnetic flux contribution of the permanent magnet 104.

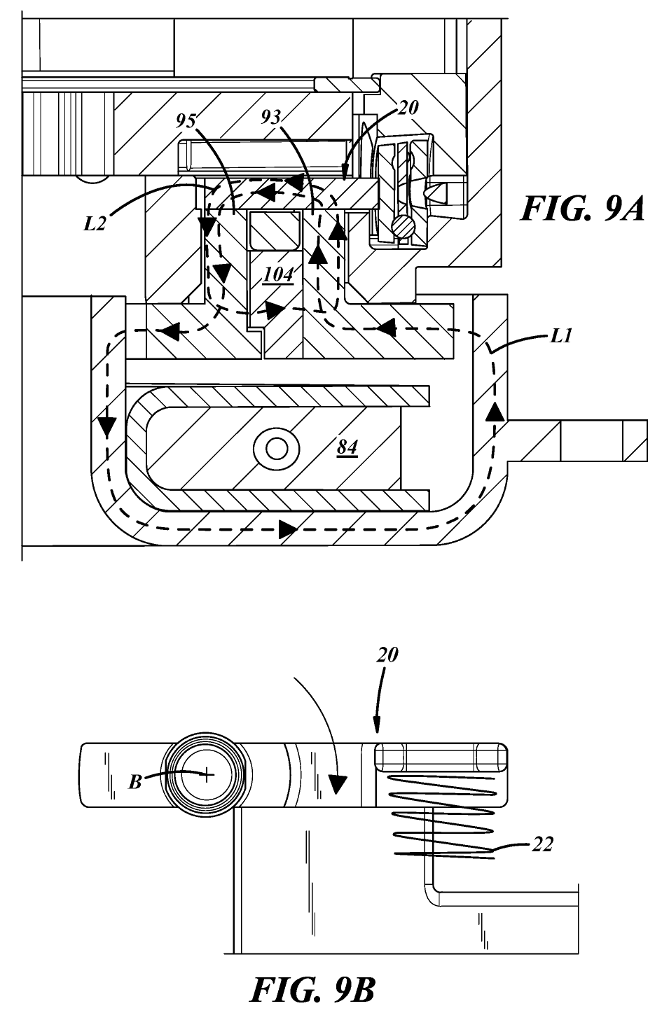

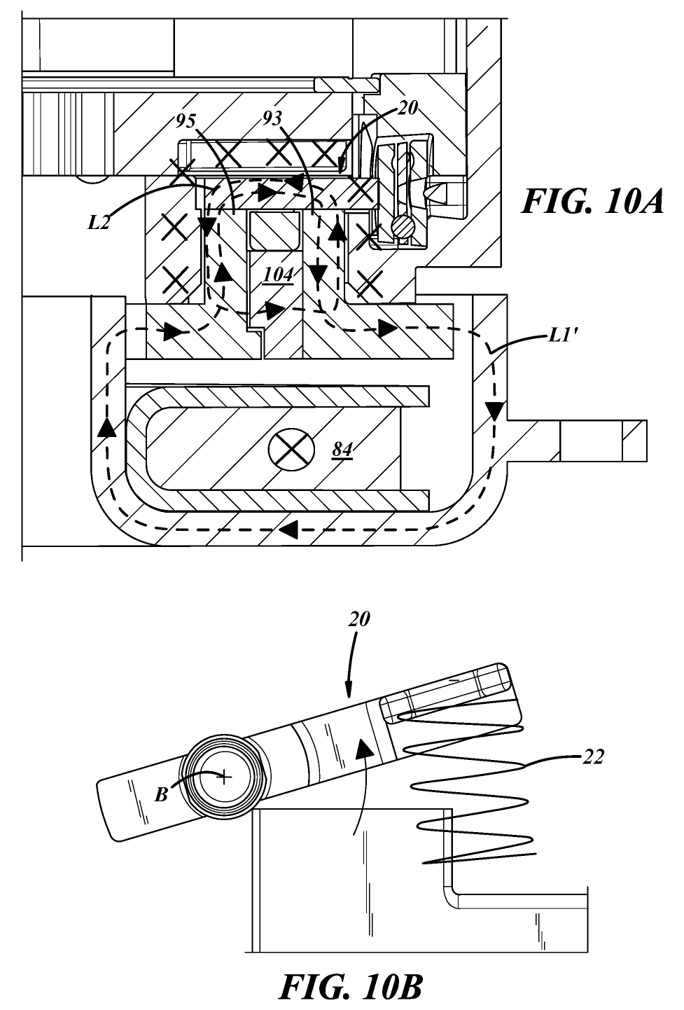

FIG. 9A illustrates the first and second magnetic loops L1, L2, and indicates directions and approximate relative magnitudes of magnetic flux in each of the loops L1, L2. FIG. 9A also indicates directions of current in the coil winding when the coil winding is energized in a manner to move the locking member to the first position (unlocked position). FIG. 10A also illustrates the second magnetic loop L2, and shows a modified first magnetic loop L1’ that is of opposite direction and less intensity or strength than the first magnetic loop L1 of FIG. 9A, and indicates magnetic flux cancellation in coinciding portions of the magnetic loops L1’, L2 when the coil winding 84 is energized in a manner to move the locking member 20, 21 to the second position (locked position).

To move the locking member 20, 21 from the second position (locked position) as shown in FIG. 10B to the first position (unlocked position) as shown in FIG. 9B, a current is applied in the coil winding 84 (as shown in FIG. 9A) to generate a selective magnetic flux contribution which matches the direction of the persistent magnetic flux contribution of the permanent magnet 104. Also, the selective magnetic flux contribution has a magnitude sufficient to produce a net magnetic force on the locking member 20, 21 that results in a torque on the locking member 20, 21 that exceeds the torque on the locking member 20, 21 resulting from the force imposed on the locking member 20, 21 by the spring 22 and pull the locking member 20, 21 to the first position (unlocked position, FIG. 9B). The required magnitude of the current is application specific and depends on the specific design parameters chosen, for example, the stiffness of the spring 22, the magnetic strength of the permanent magnet 104, and/or the size of one or more of the air gaps. The required direction of the current is also application specific and also depends on the specific design parameters, for example, the direction that the coil winding 84 is wound, and/or the magnetization direction of the permanent magnet 104. For the configuration shown in FIG. 9A, the permanent magnets 104 are magnetized radially outward, so the current comes out of the page relative to the cross-sectional view.

To move the locking member 20, 21 from the first position (unlocked position) as shown in FIG. 9B to the second position (locked position) as shown in FIG. 10B, a current is applied in the coil winding 84 (as shown in FIG. 10A) to generate a selective magnetic flux contribution which opposes the direction of the persistent magnetic flux contribution of the permanent magnet 104. Also, the selective magnetic flux contribution has a magnitude sufficient to produce a net magnetic force on the locking member 20, 21 that may be approximately zero, thereby allowing the spring 22 to push the locking member 20, 21 up into the second position (locked position, FIG. 10B). The current does not need to be controlled so precisely that the net magnetic force is exactly zero, but rather just enough to reduce the net magnetic force so that the spring 22 can overcome the net magnetic force. The magnitude required is application specific and depends on the specific design parameters such as the magnetic strength of the magnet 104, the stiffness of the spring 22, and the size of one or more of the air gaps. The required direction of the current is application specific and also depends on the specific design parameters such as the direction that the coil winding 84 is wound, and the magnetization direction of the permanent magnet 104. For the configuration shown in FIG. 10A, the permanent magnets 104 are magnetized radially outward, so the current goes into the page relative to the cross-sectional view.

With continued reference to FIGS. 9A-10B, the first and second pole pieces 93, 95 are configured to magnetically interface with the respective locking member 20, 21 on a side of the pivot axis B such that the net magnetic force pulls the locking member 20, 21 into the first position (unlocked position), in the illustrated embodiment. In other embodiments, however, the first and second pole pieces 93, 95 may be configured to magnetically interface with the respective locking member 20, 21 on a side of the pivot axis B such that the net magnetic force pulls the locking member 20, 21 into the second position (locked position) instead of the first position (unlocked position). Such embodiments would be paired with a corresponding configuration of the spring 22 so that the spring 22 also acts on the locking member 20, 21 to urge it toward the first position (unlocked position) instead of the second position (locked position). In other words, if the ‘front’ of the locking member 20, 21 is defined as the end of the locking member 20, 21 that engages with the first engagement surface 34 of the locking formation 32, then the shown clutch system 10 is arranged so that the first and second pole pieces 93, 95 magnetically interface with the locking member 20, 21 in a location forward of the pivot axis B. But the clutch system 10 may be modified so that the first and second pole pieces 93, 95 magnetically interface with the respective locking member 20, 21 in a location rearward of the pivot axis B of that locking member 20, 21.

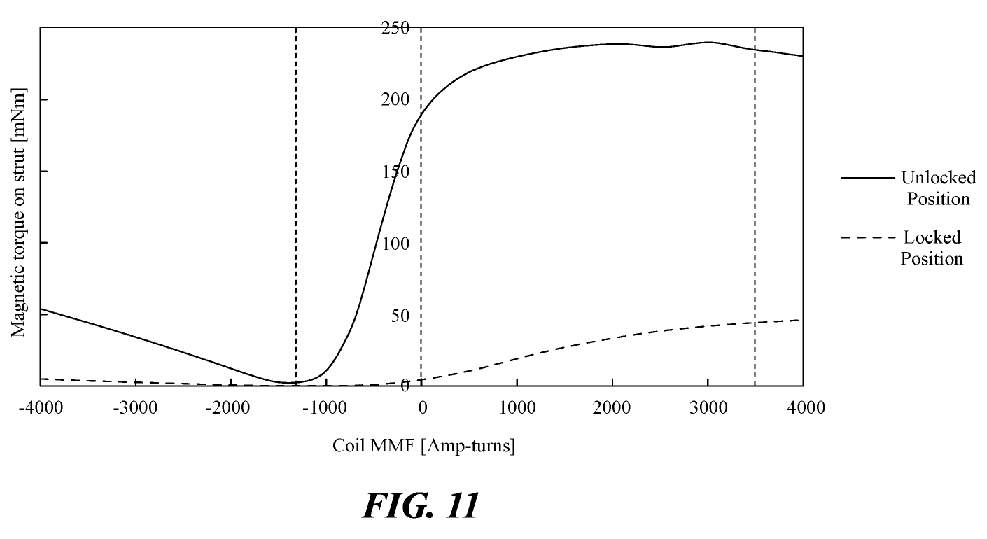

Referring now to FIG. 11, and with general reference to FIGS. 1-10, a graph shows simulation results of operation of the clutch system 10, specifically a net torque on the locking member 20, 21 as a function of coil magnetomotive force (MMF), for both the first position (unlocked position) and the second position (locked position) of the locking member, and indicating three example operating points. The horizontal axis represents the amount of MMF (amp-turns) in the coil winding 84, with positive MMF corresponding to a current that flows out of the page as in FIG. 9A and negative MMF corresponding to a current that flows into the page as in FIG. 10A. The vertical axis represents the amount of torque exerted on the locking member 20, 21 by the net magnetic force, with positive torque urging the locking member 20, 21 toward the first position (unlocked position, FIG. 9B). The three vertical lines represent example operating points of the coil winding 84. The middle operating point is at 0 amp-turns. This shows that when there is no current in the coil winding 84, the magnetic torque on the locking member 20, 21 is relatively high when the locking member 20, 21 is in the first position (unlocked position), and it is relatively low when the locking member 20, 21 is in the second position (locked position). The operating point on the right is at +3500 amp-turns, and this corresponds to actuating the locking member 20, 21 toward the first position (unlocked position) as in FIGS. 9A and 9B. This shows that at this operating point, the magnetic torque on the locking member 20, 21 is at least moderately high for its entire range of motion. The operating point on the left is at -1375 amp-turns, and this corresponds to actuating the locking member 20, 21 toward the second position (locked position) as in FIGS. 10A and 10B. This shows that at this operating point, the magnetic torque on the locking member 20, 21 is relatively low for its entire range of motion. The specific numbers on this graph are representative only of one embodiment of the clutch system 10, and modifications of the dimensions, materials, or chosen operating points will produce different numbers.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. An electromagnetic clutch, comprising:
first and second coupling members supported for rotation relative to one another about a common rotational axis, the first and second coupling members including first and second faces in opposition with one another, the second coupling member having a third face spaced from the second face, the second face having a pocket, the first face having a set of locking formations, and the third face having at least one passage in communication with the pocket;
magnetic circuit components including:
a ferrous locking member received in the pocket in an unlock position and projecting outwardly from the pocket in a lock position;
an electromagnet including:
first and second poles, and
an excitation coil that generates a selective magnetic field between the first and second poles when the excitation coil is supplied with current; and
magnetic first and second inserts received in the at least one passage of the second coupling member, the first and second inserts being in opposition across first and second air gaps with the first and second poles of the electromagnet, the first and second inserts being in opposition across third and fourth air gaps with first and second spaced portions of the ferrous locking member, wherein the electromagnet, the first and second inserts, the air gaps, and the ferrous locking member constitute a closed-loop path of magnetic flux so that the ferrous locking member moves between the unlock and lock positions when the excitation coil is supplied with current; and
a permanent magnet between the first and second inserts.

2. The electromagnetic clutch of claim 1, wherein the permanent magnet provides a persistent magnetic field that combines with the selective magnetic field of the excitation coil to influence motion of the ferrous locking member between the unlock and lock positions.

3. The electromagnetic clutch of claim 1, wherein the permanent magnet magnetically interfaces with the first and second inserts so that the permanent magnet, the first and second inserts, and the ferrous locking member constitute a closed-loop path of magnetic flux.

4. A clutch system comprising:
a coupling subsystem including:
a first coupling member;
a second coupling member; and
a locking member operatively positioned between the first coupling member and the second coupling member, and movable between a first position and a second position; and
an actuator subsystem including:
an electromagnetic coil assembly including
an electromagnetic coil winding; and
a coil housing having a first pole and a second pole,
wherein the electromagnetic coil assembly is configured so that magnetic flux is produced in the coil housing when the electromagnetic coil winding is energized with current;
a first pole extension rotatable with the second coupling member, the first pole extension magnetically interfacing with the first pole of the coil housing and magnetically interfacing with the locking member;
a second pole extension rotatable with the second coupling member, the second pole extension magnetically interfacing with the second pole of the coil housing and magnetically interfacing with the locking member; and
a permanent magnet rotatable with the second coupling member, the permanent magnet magnetically interfacing with the first pole extension and magnetically interfacing with the second pole extension,
wherein the coil housing, the first pole extension, the second pole extension, and the locking member form a first magnetic loop so that magnetic flux generated by the electromagnetic coil winding is extendable to the locking member through the first and second pole extensions, and
wherein the permanent magnet, the first pole extension, the second pole extension, and the locking member form a second magnetic loop so that magnetic flux generated by the permanent magnet is extendable to the locking member through the first and second pole extensions.

5. The clutch system of claim 4, wherein the electromagnetic coil winding passes through the first magnetic loop.

6. The clutch system of claim 4, wherein:
the first coupling member includes a first engagement surface;
the second coupling member includes a second engagement surface;
the locking member does not contact the first engagement surface when the locking member is in the first position; and
the locking member contacts the first and second engagement surfaces when the locking member is in the second position, thereby preventing relative rotation between the first and second coupling members in at least one direction.

7. The clutch system of claim 4, wherein the permanent magnet is magnetized in a direction extending away from the first pole extension toward the second pole extension.

8. The clutch system of claim 4, further comprising means for biasing the locking member to either the first position or the second position.

9. The clutch system of claim 4, wherein the second coupling member is rotatable about a rotational axis and the locking member moves in an axial direction relative to the rotational axis of the second coupling member.

10. The clutch system of claim 4, wherein the locking member, the first and second pole extensions, and the coil housing are made from a material that is magnetically responsive.

11. The clutch system of claim 4, wherein the second coupling member is made from a material that is not magnetically responsive.

12. The clutch system of claim 4, wherein the first and second coupling members are both rotatable and the electromagnetic coil assembly is non-rotating.

13. The clutch system of claim 4, wherein at least one of the first or second pole extensions includes pole pieces extending into corresponding pole passages of the second coupling member.

14. An electromagnetic clutch, comprising:
a coupling subsystem including
a first coupling member having a locking formation;
a second coupling member in opposition with the first coupling member and having a pocket; and
a locking member that is carried by the pocket of the second coupling member, is engaged with the locking formation of the first coupling member in a locked position of the locking member to transmit torque between the first and second coupling members, and is disengaged from the locking formation in an unlocked position of the locking member; and
an actuator subsystem including
first and second pole extensions rotatable with the second coupling member;
a permanent magnet that generates a persistent magnetic flux contribution within the first and second pole extensions, the persistent magnetic flux contribution influencing motion of the locking member between the locked and unlocked positions; and
an electromagnetic coil that generates a selective magnetic flux contribution within the first and second pole extensions, the selective magnetic flux contribution influencing motion of the locking member between the locked and unlocked positions, magnitude and direction of the selective magnetic flux contribution being variable according to magnitude and direction of current in the electromagnetic coil, the selective magnetic flux contribution superimposing with the persistent magnetic flux contribution of the permanent magnet to create a net magnetic force acting on the locking member that can be varied selectively.

15. The electromagnetic clutch of claim 14, wherein the coupling subsystem further includes a spring that imposes a spring force on the locking member to urge the locking member toward the locked position or the unlocked position, and the persistent magnetic flux contribution urges the locking member toward the unlocked position in an absence of the selective magnetic flux contribution.

16. The electromagnetic clutch of claim 15, wherein
when the locking member is in the locked position in the absence of the selective magnetic flux contribution, the spring force urges the locking member toward the locked position more strongly than the persistent magnetic flux contribution urges the locking member toward the unlocked position, so the locking member is stable in the locked position, and
when the locking member is in the unlocked position in the absence of the selective magnetic flux contribution, the persistent magnetic flux contribution produces the net magnetic force that urges the locking member toward the unlocked position more strongly than the spring force urges the locking member toward the locked position, so the locking member is stable in the unlocked position.

17. The electromagnetic clutch of claim 16, wherein
when the locking member is in the locked position, a selective magnetic flux contribution, with a direction matching that of the persistent magnetic flux contribution, causes the net magnetic force on the locking member to produce a torque on the locking member that overcomes another torque on the locking member resulting from the spring force and thereby moves the locking member toward the unlocked position.

18. The electromagnetic clutch of claim 16, wherein
when the locking member is in the unlocked position, a selective magnetic flux contribution, with a direction opposing that of the persistent magnetic flux contribution, causes the net magnetic force on the locking member to produce a torque on the locking member that is overcome by another torque on the locking member resulting from the spring force and thereby moves the locking member toward the locked position.

19. The electromagnetic clutch of claim 14, wherein the net magnetic force operates on the locking member in a location forward of a pivot axis of the locking member.

20. The electromagnetic clutch of claim 14, wherein at least one of the first or second pole extensions includes pole pieces extending into corresponding pole passages of the second coupling member.
